(19) United States
(12) Patent Application Publication
(10) Pub. No.: US 2008/0119231 A1
(43) Pub. Date: May 22, 2008

(54) Switchable divider and combiner assembly having multiple inputs and outputs

(76) Inventors: Yeung Jun Kim, Placentia, CA (US); Junwon Heo, Irvine, CA (US); Kuk-Yong Kim, Yongin-Si (KR)

Correspondence Address: ALBERT O COTA, 5460 WHITE OAK AVE, SUITE A-331, ENCINO, CA, 91316, US

(21) Appl. No.: 11/888,447

(22) Filed: Aug. 2, 2007

Related U.S. Application Data
(60) Provisional application No. 60/860,067, filed on Nov. 20, 2006.

(51) Int. Cl. H04M 1/00

(52) U.S. Cl. 455/562.1

(57) ABSTRACT

A switchable divider and combiner assembly (SDCA) (10) that includes a base station (12) that encloses a transceiver circuit (14), a transmitting section (16), a receiving section (30) and a control circuit (40). The sections (16,30) each include a switchable divider circuit (18) and a swithable combiner circuit (24). The transceiver circuit (14) interfaces with a remote data processing/receiving network (50) and with the transmitting and receiving sections (16,30). The sections (16,30) also communicate with a remote user (52) via antennae (20,36). The SDCA (10) functions by transmitting and receiving multiple input and output signals that are alternately and electronically controlled and switched by the control circuit (40).

This application claims priority of Provisional Patent Application No. 60/860,067 filed Nov. 20, 2006.

### TECHNICAL FIELD

The invention generally pertains to the field of mobile communication dividers and combiners, and more particularly to a switchable divider and combiner assembly. The assembly has multiple inputs and outputs that are configured in a circulating configuration and that are electronically selected and controlled.

### BACKGROUND ART

The field of mobile communication is a rapidly growing and evolving industry that encompasses world-wide participation. A mobile communication divider is initially assigned by a Government agency a frequency band. The frequency band is then divided by the provider into a plurality of subordinate frequency bands that are assigned to at least one service area. The service area is configured as an omni directional cell or sector. The sector is further divided by the provider in accordance with the type of service area, i.e residential or commercial, and the number of expected subscribers.

The service area is typically divided into three sectors that are controlled and operated by a base station. The subordinate frequency bands or Frequency Assignment (FA) are assigned to cover a maximum call rate in each sector. For example, if one sector requires three FAs, a total of nine FAs are required in a base station in addition to the hardware and software required to operate the nine FAs. Therefore, a service provider normally assigns two FAs at each sector. Also, the service provider can assign one FA to a near sector having a low call rate in lieu of the normally required three FAs. If an FA is dynamically assigned to a base station, the base station is able to operate with six FAs instead of the normally required nine FAs. If the base station operates with nine FAs, its efficiency is improved if the FAs are increased from three to four.

In summary, existing mobile communication technology has a large insertion loss and operating costs are high. The inventive switchable divider and combiner assembly includes multiple, electronically operated inputs and outputs which lower insertion losses. Operating costs are also reduced due to the assembly having a high reliability and low incidents of preventive-maintenance cycles.

A search of the prior art did not disclose any industry literature or U.S. patents that read directly on the claims of the instant invention. However, the following publication and U.S. patents are considered related: U.S. Patent Application Publication No. US2005/0134512A1 issued: 23 Jun. 2005, Inventor: Gottl, et al.

| PATENT | INVENTOR | ISSUED |
|---|---|---|
| 6,735,432 | Jarett, et al | 11 May 2004 |
| 6,476,746 | Viswanathan | 5 Nov. 2002 |
| 5,911,120 | Jarett, et al | 8 Jun. 1997 |

The US2005/0134512A1 publication discloses a mobile radio antenna arrangement for a base station that includes a radome that houses the antenna elements and a vertical pivoting device that has attached a reflector. The interior of the radome is dimensioned to allow the reflector and the antenna elements to be pivoted in the azimuth direction relative to the radome.

The U.S. Pat. No. 6,735,432 patent and the U.S. Pat. No. 5,911,120 patent disclose a mobile station that communicates with both a cellular network and a cordless cellular base station. The cordless cellular base station is connected to a public-switched telephone network and is assigned a landline number. The cordless cellular base station acts as a conduit between the mobile station and the public-switched telephone network. When the mobile station comes within range of a cordless cellular base station, it de-registers automatically from the cellular network and registers with the cordless cellular base station.

The U.S. Pat. No. 6,476,746 patent discloses a digital cellular base station that is adapted to support high speed communication. The base station includes a digital signal processor, a digital-to-analog converter (DAC), a RF modulator and an antenna. The processed signal is applied to the DAC where the signal is processed and converted into an analog signal. The analog signal is subsequently modulated by the RF modulator into a broadcasting frequency that is applied onto space through the antenna.

### DISCLOSURE OF THE INVENTION

The switchable divider and combiner assembly (SDCA) is designed to be used in combination with a data processing/receiving network and a user. The network produces an output signal 11 and receives an input signal 13. The user is applied a Po1 signal and produces a Pi1 signal.

In its basic design configuration, the SDCA consists of a base station that houses:
A transceiver circuit having means for receiving and processing the output signal 11 and producing an input signal Pi1,
A transmitting section 16 comprising a divider circuit 18 having means for dividing the input signal Pi1 into an output signal Po1 and an output signal Po5. The two signals are applied to a combiner circuit 24, where the two signals are combined to produce an output signal Po1. The signal Po1 is transmitted into space and is received by the user 52,
A receiving section 30 comprising a divider circuit 18 having a receiving antenna 36 that intercepts an input signal Pi1 that is applied form the user 52. The divider circuit 18 has means for dividing the input signal Pi1 into an output signal Po1 and an output signal Po5. The two signals are applied to a combiner circuit 24 where the two signals are combined to produce an output signal Po1 that is applied to the transceiver circuit 14 from where an input signal 13 is produced and applied to the data processing/receiving network 50, and
A control circuit 40 that having means for electronically controlling the operation of the transmitting section 16 and the receiving section 30.

In view of the above disclosure it is the primary object of the invention to provide an SDCA having a divider that electronically decodes M incoming signals, and a combiner that electronically combines the M signals into N outgoing signals.

In addition to the primary object of the invention it is also an object of the invention to provide an SDCA that:
has a high reliability and a low preventive-maintenance cycle,
reduces switch connection points and the number of cables that are required to operate other divider and combiner systems,
includes redundancy ports that can be utilized in the event of a port failure,
can be designed to be operated with fewer signal transmission lines, and
is cost effective from both a manufacturer's and consumer's point of view.

These and other objects and advantages of the present invention will become apparent from the subsequent detailed description of the preferred embodiment and the appended claims taken in conjunction with the accompany drawings.

### BRIEF DESCRIPTION OF THE DRAWINGS

FIG. 1 is a block diagram showing the elements that comprise the switchable divider and combiner assembly (SDCA).

FIG. 2 is a schematic/block diagram of the transmitting section shown in FIG. 1.

FIG. 3 is a schematic/block diagram of the receiving section shown in FIG. 1.

FIG. 4 is a schematic diagram showing five circulating configurations that can be utilized to operate the divider circuit.

FIG. 5 is a schematic diagram showing five circulating configurations that can be utilized to operate the combiner circuit.

FIG. 6 is a schematic diagram showing an SDCA having three input ports, three output ports and six switches.

FIG. 7 is a schematic diagram showing a pair of incoming signals and a pair of input ports that are connected to an output port.

FIG. 8 is a schematic diagram showing an input port that is connected through a seventh switch to an output port that is connected to a combiner that receives four incoming signals that produce three outgoing signals.

FIG. 9 is a schematic diagram that when included with FIG. 8 adds a fifth input port.

FIG. 10 is a schematic diagram that when combined with FIG. 6 provides three additional input ports for receiving incoming signals.

FIG. 11 is a schematic diagram showing three input ports, three output ports and six switches.

FIG. 12 is a schematic diagram showing three input ports, three output ports and six switches.

FIG. 13 is a schematic diagram showing an incoming signal that is applied to an input port that is divided and applied through two output ports.

FIG. 14 is a schematic diagram showing a fourth output port.

FIG. 15 is a schematic diagram that when combined with FIG. 14 adds a fifth output port.

FIG. 16 is a schematic diagram that when combined with FIG. 12 adds three output ports and six switches.

FIG. 17 is a schematic diagram showing three input ports, three output ports and six switches.

FIG. 18 is a schematic diagram showing three output ports that are each connected to “n” input ports.

FIG. 19 is a schematic diagram showing three input ports that are each connected to “n” output ports.

FIG. 20 is a software flow diagram that is used by the microcontroller to operate the SDCA.

### BEST MODE FOR CARRYING OUT THE INVENTION

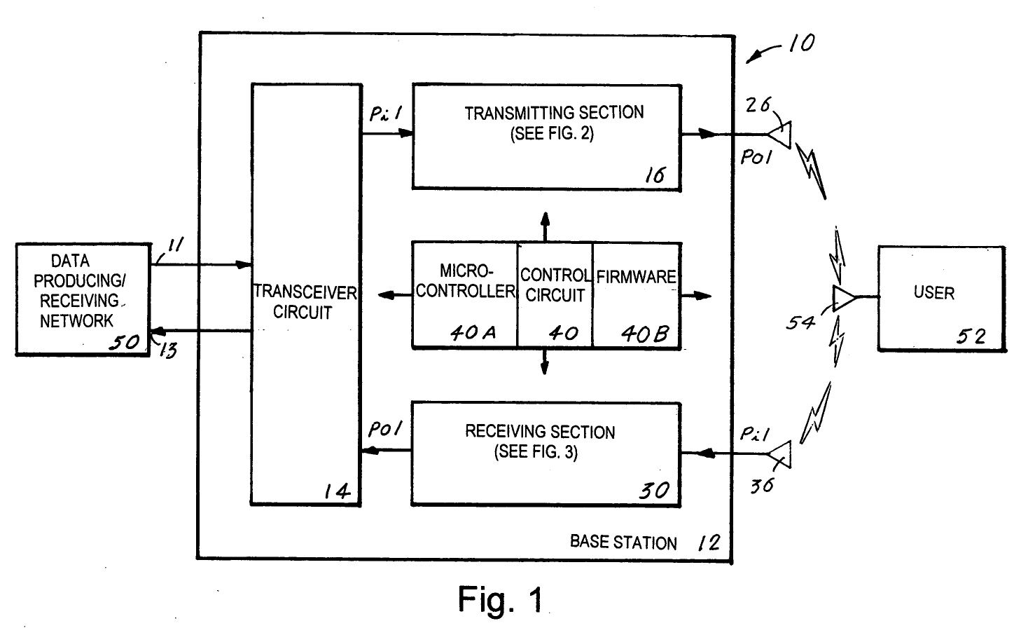

The best mode for carrying out the invention is presented in terms of a preferred embodiment for a switchable divider and combiner assembly 10 (hereinafter “SDCA 10”) having multiple inputs and outputs. The preferred embodiment, as shown in FIGS. 1-20, is comprised of a base station 12, as shown in FIG. 1, that is comprised of four major elements: a transceiver circuit 14, a transmitting section 16, a receiving section 30 and a control circuit 40. The SDCA 10 functions in combination with an existing data producing/receiving network 50 and a user 52, as also shown in FIG. 1.

The transceiver circuit 14, as shown in FIG. 1, has means for receiving and processing an input signal 11 that is applied from the data producing/receiving network 50 and an output signal (Po1) that is applied from the receiving section 30. The output of the transceiver circuit 14, as also shown in FIG. 1, is an output signal 13 that is applied to the data producing/receiving network 50 and a (Pi1) signal that is applied to the transmitting section 16.

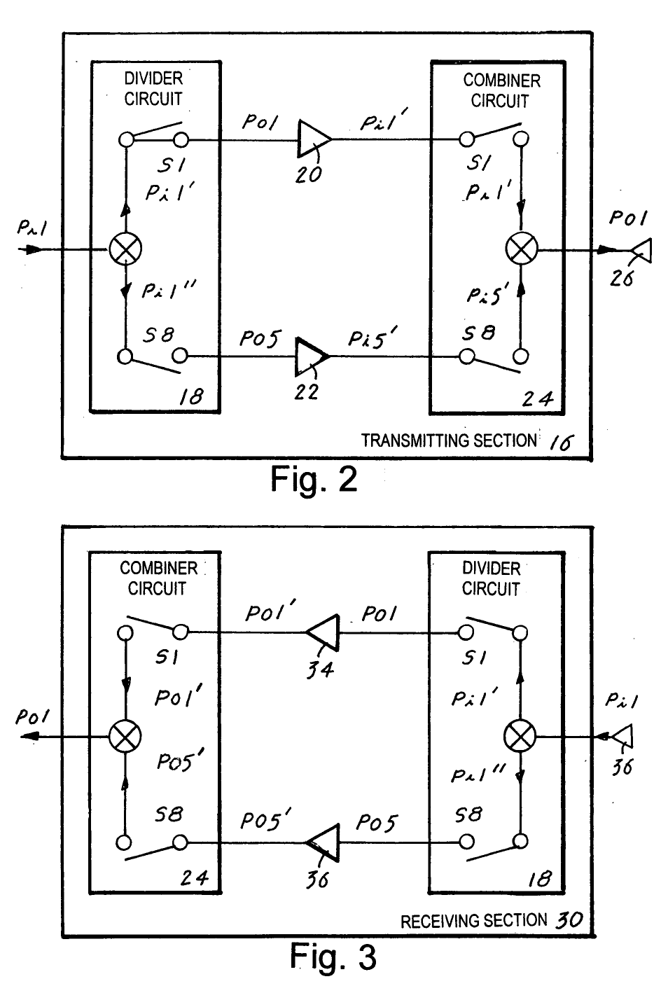

The transmitting section 16, as shown in FIG. 2, is comprised of a divider circuit 18, an RF power amplifier 20, a low-noise RF power amplifier 22 and a combiner circuit 24. The divider circuit 18 has means for dividing and switching the input signal (Pi1) into a first signal (Pi1′) and a second signal (Pi1″). The first signal (Pi1′) is applied to a first switch (S1), and the second signal (Pi1″) is applied to an eighth switch (S8). When the first switch (S1) closes, an output signal (Po1) is produced, and when the eighth switch (S8) closes, an output signal (Po5) is produced. The output signal (Po1) from the first switch (S1) is applied to the RF power amplifier 20 that is designed to produce an amplified input signal (Pi1′), and wherein the output signal (Po5) from the eighth switch (S8) is applied to a low-noise RF power amplifier 22 that is designed to produce an amplified input signal (Pi5′).

The combiner circuit 24, as also shown in FIG. 1, is comprised of a first switch (S1) and an eighth switch (S8). The first switch (S1) is applied the amplified input signal (Pi1′) and the eighth switch (S8) is applied the amplified input signal (Pi5′). When the two switches (S1,S8) close, the two signals (Pi1′) and (Pi5′) are combined to produce an output signal (Po1) that is applied to the RF transmitting antenna 26 that transmit the output signal (Po1) into space, as shown in FIG. 1. The output signal (Po1) is intercepted by a transmitting/receiving antenna 54 from where the signal is applied to the user 52.

The receiving section 30, as shown in FIG. 3, is comprised of a divider circuit 18, an RF power amplifier 34, a low-noise RF power amplifier 36, and a combiner circuit 24.

The divider circuit 18 is connected to a receiving antenna 36, as shown in FIG. 3, that intercepts an input signal (Pi1) that is produced by the user 52, and that is applied to the divider circuit 18. The circuit 18 has means for dividing and switching the input signal (Pi1) into a first signal (Pi1′) and a second signal (Pi1″). The first signal (Pi1′) is applied to a first switch (S1), and the second signal (Pi1″) is applied to an eighth switch (S8). When the first switch (S1) closes, an output signal (Po1) is produced, and when the eighth switch (S8) closes, an output signal (Po5) is produced. The output signal (Po1) from the first switch (S1) is applied to the RF power amplifier 34 that is designed to produce an amplified output signal (Po1′). The low-noise RF power amplifier 36 receives the output signal (Po5) from the eighth switch (S8) and produces an amplified output signal (Po5′).

The combiner circuit 24 is comprised of a first switch (S1) and an eighth switch (S8). The first switch (S1) is applied the amplified output signal (Po1′), and the eighth switch (S8) is applied the amplified input signal (Po5′). When the two switches (S1,S8) close, the two signals (Po1′) and (Po5′) are combined by the combiner circuit 24 to produce an output signal (Po1). The signal (Po1) is applied to the transceiver circuit 14 from where the output signal 13 is produced and applied to the data producing/receiving network 50.

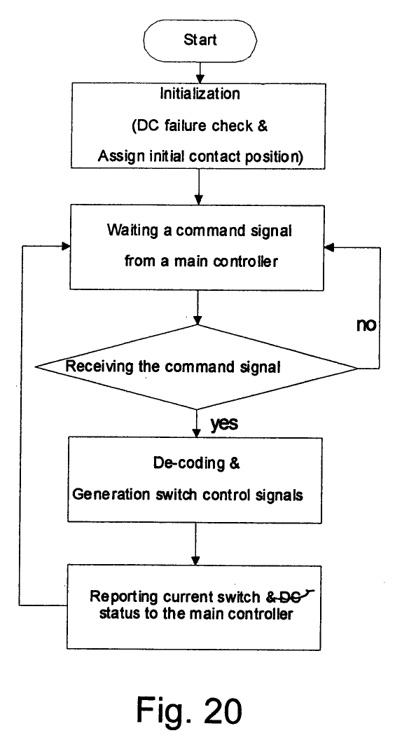

The control circuit 40, as shown in FIG. 1, is comprised of a microcontroller 40A that is operated by firmware 40B. The control circuit 40 has means for selecting and controlling the operating sequence of the switches (S1 and S8) located in the transmitting section 16 and the switches (S1 and S8) located in the receiving section 30. The firmware 40B, as shown in FIG. 20, is comprised of the following steps:
a) start,
b) initialization,
c) waiting for a command signal from the microcontroller 40A,
d) receiving the command signal from the microcontroller 40A,
e) decoding the command signal and
f) reporting the current switch status to the microcontroller 40A.

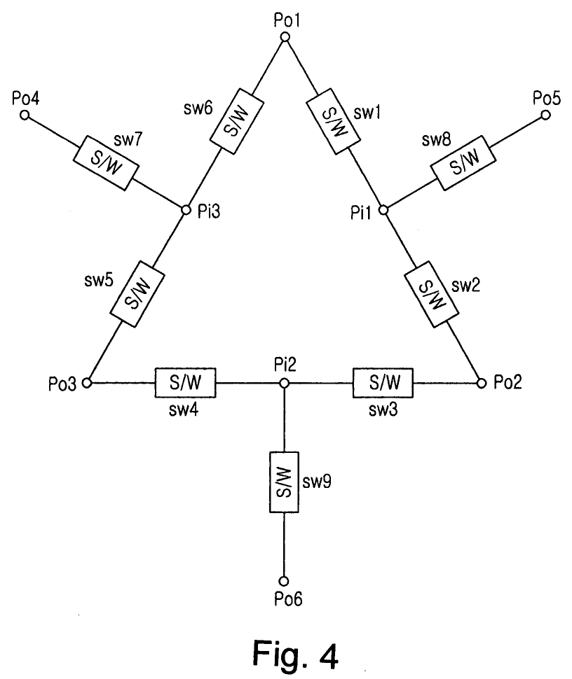

The switches and the signals that are utilized in the SDCA 10 function in a circulating configuration, as shown best in FIGS. 4-19. Only the switches and the corresponding input and output ports are shown in FIGS. 4-19. However, it is to be understood that the divider circuit 18 and the combiner circuit 24 are an integral element of the circulating configuration.

As shown in FIG. 4, the divider circuit 18 is further comprised of five additional circulating configurations.

In the second configuration the divider circuit 18 is comprised of:
a) an input signal (Pi1),
b) a second switch (S2),
c) an eighth switch (S8),
d) an output signal (Po2), and
e) an output signal (Po5).

The input signal (Pi1) is divided by the divider circuit 18 into a first signal and a second signal. The first signal is applied to the second switch (S2), wherein when the second switch (S2) closes the output signal (Po2) is produced. The second signal is applied to the eighth switch (S8), wherein when the eighth switch (S8) closes the output signal (Po5) is produced.

The third configuration of the divider circuit 18 is comprised of:
a) an input signal (Pi2),
b) a third switch (S3),
c) a ninth switch (S9),
d) an output signal (Po2), and
e) an output signal (Po6).

The input signal (Pi2) is divided by the divider circuit 18 into a first signal and a second signal. The first signal is applied to the third switch (S3), wherein when the third switch (S3) closes, the output signal (Po2) is produced. The second signal is applied to the ninth switch (S9), wherein when the ninth switch (S9) closes, the output signal (Po6) is produced.

The fourth configuration of the divider circuit 18 is comprised of:
a) an input signal (Pi2),
b) a fourth switch (S4),
c) a ninth switch (S9),
d) an output signal (Po3), and
e) an output signal (Po6).

The input signal (Pi2) is divided by the divider circuit 18 into a first signal and a second signal. The first signal is applied to the fourth switch (S4), wherein when the fourth switch (S4) closes, the output signal (Po3) is produced. The second signal (Pi2) is applied to the ninth switch (S9), wherein when the ninth switch (S9) closes, the output signal (Po6) is produced.

The fifth configuration of the divider circuit 18 is comprised of:
a) an input signal (Pi3),
b) a sixth switch (S6),
c) a seventh switch (S7),
d) an output signal (Po1), and
e) an output signal (Po4).

The input signal (Pi3) is divided by the divider circuit 18 into a first signal and a second signal. The first signal is applied to the sixth switch (S6), wherein when the sixth switch (S6) closes, the output signal (Po1) is produced. The second signal is applied to the seventh switch (S7), wherein when the seventh switch (S7) closes, the output signal (Po4) is produced.

The sixth configuration of the divider circuit 18 is comprised of:
a) an input signal (Pi3),
b) a fifth switch (S5),
c) a seventh switch (S7),
d) an output signal (Po3), and
e) an output signal (Po4).

The input signal (Pi3) is divided by the divider circuit 18 into a first signal and a second signal. The first signal is applied to the fifth switch (S5), wherein when the fifth switch (S5) closes, the output signal (Po3) is produced. The second signal is applied to the seventh switch (S7), wherein when the seventh switch (S7) closes, the output signal (Po4) is produced.

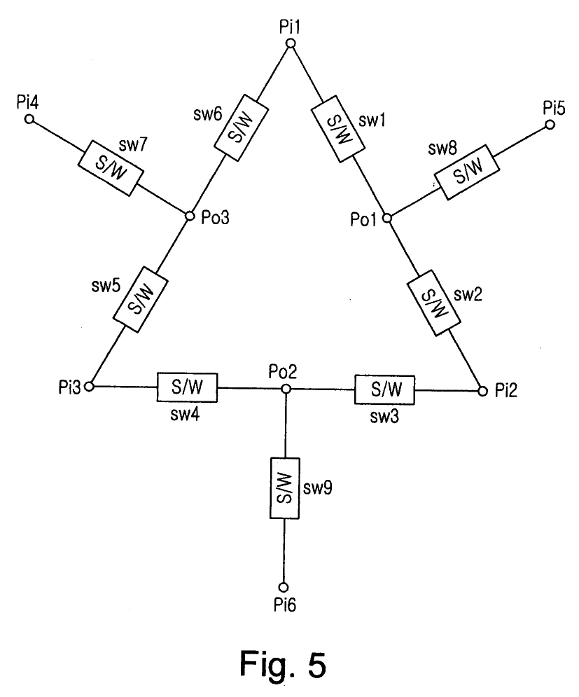

As shown in FIG. 5, the combiner circuit 24 is further comprised of five additional circulating configurations.

In the second configuration the combiner circuit 24 is comprised of:
a) an input signal (Pi1),
b) an input signal (Pi4),
c) a sixth switch (S6),
d) a seventh switch (S7), and
e) an output signal (Po3).

The sixth switch (S6) is applied the input signal (Pi1), and the seventh switch (S7) is applied the input signal (Pi4). When the switch (S6) and the switch (S7) close, the two signals (Pi1) and (Pi4) are combined to produce an output signal (Po3).

In the third configuration the combiner circuit 24 is comprised of:
a) an input signal (Pi2),
b) an input signal (PiS),
c) a second switch (S2),
d) a sixth switch (S6), and
e) an output signal (Po1).

The second switch (S2) is applied the input signal (Pi2), and the sixth switch (S6) is applied the input signal (Pi5). When the switch (S2) and the switch (S6) close, the two signals (Pi2) and (Pi5) are combined to produce an output signal (Po1).

In the fourth configuration the combiner circuit 24 is comprised of
a) an input signal (Pi3),
b) an input signal (Pi6),
c) a fourth switch (S4),
d) a ninth switch (S9), and
e) an output signal (Po2).

The fourth switch (S4) is applied the input signal (Pi3), and the ninth switch (S9) is applied the input signal (Pi6). When the switch (S4) and the switch (S9) close, the two signals (Pi3) and (Pi6) are combined to produce an output signal (Po2).

In the fifth configuration the combiner circuit 24 is comprised of:
a) an input signal (Pi3),
b) an input signal (Pi4),
c) a fifth switch (S5),
d) a seventh switch (S7), and
e) an output signal (Po3).

The fifth switch (S5) is applied the input signal (Pi3), and the seventh switch (S7) is applied the input signal (Pi4). When the switch (S5) and the switch (S7) close, the two signals (Pi3) and Pi4) are combined to produce an output signal (Po3).

In the sixth configuration the combiner circuit 24 is comprised of:
a) an input signal (Pi2),
b) an input signal (Pi6),
c) a third switch (S3),
d) a ninth switch (S9), and
e) an output signal (Po2).

The third switch (S3) is applied the input signal (Pi2), and the ninth switch (S9) is applied the input signal (Pi6). When the switch (S3) and the switch (S9) close, the two signals (Pi2 and Pi6) are combined to produce an output signal (Po2).

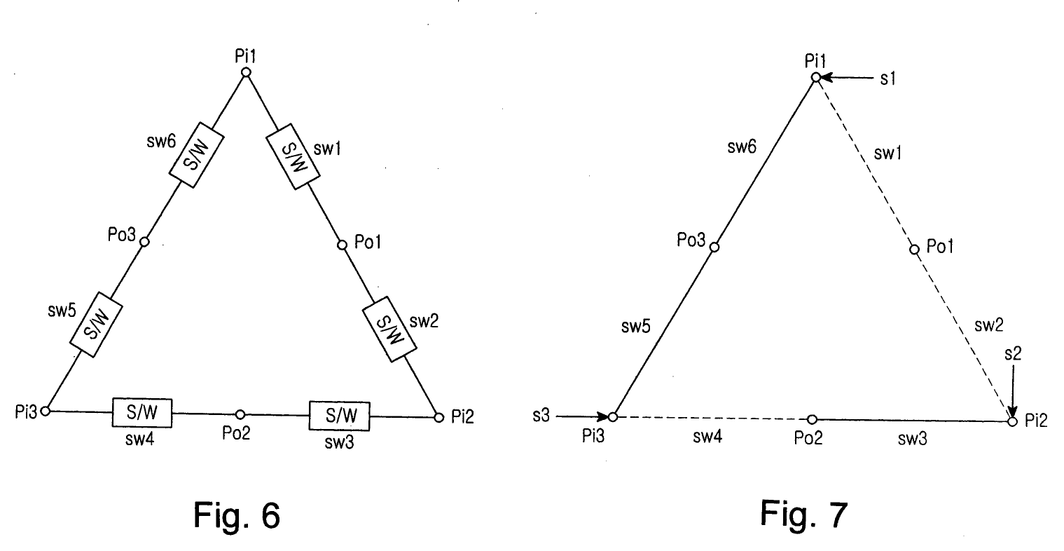

The remaining circulating series configuration of the SDCA 10 are described with reference to FIGS. 6-19.

FIG. 6 depicts an SDCA 10 having three input ports (Pi1, Pi2, Pi3), three output ports (Po1, Po2, Po3), and six switches (sw1-sw6). The switches alternatively connect the three input ports and the three output ports to each other in a circulating configuration. The operational sequence of the switches is controlled by a set of switching control signals provided by the control circuit 40, as shown in FIGS. 1-3.

FIG. 7 depicts a pair of incoming signals (s1, s3), and a pair of input ports (Pi1, Pi3) that are connected to an output port (Po3). An incoming signal (s2) is also shown at the input port (Pi2) that is connected to the output port (Po2). This configuration includes three switches (sw1, sw2 and sw4) that are normally off and three switches (sw3, sw5 and sw6) are normally on. The incoming signal (s1) that is applied from the input port (Pi1) and the incoming signal (s3) that is applied from the input port (Pi3) are combined and applied through the output port (Po3). The incoming signal (s2) that is applied from the input port (Pi2) is applied through the output port (Po2). In this application, a 3:3 switchable combiner receives three incoming signals from the three input ports and applies the signals through the three outputs ports. The output direction of the incoming signals depends on the status of the switches which are controlled by the signals applied from the control circuit 40, as shown in FIGS. 1-3.

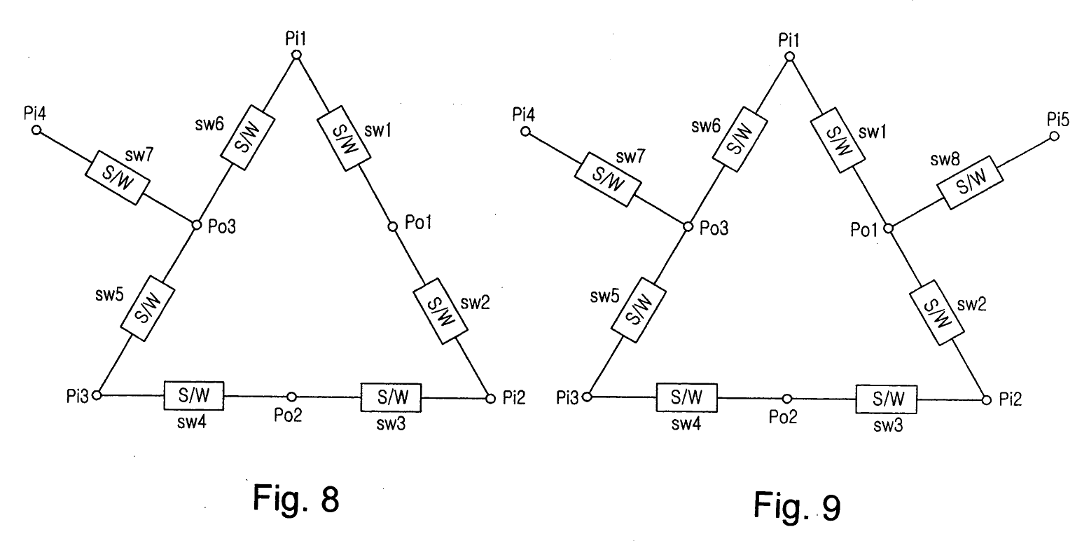

FIG. 8 depicts an input port (Pi4) that is connected through a seventh switch (S7) to an output port (Po3) which is connected to a 4:3 switchable combiner that receives four incoming signals and that produces three outgoing signals. The third output port (Po3) combines a maximum of three input signals.

FIG. 9 depicts a configuration that, when included with FIG. 8, adds a fifth input port (PiS). When an eighth switch connects the output port (Po1) to a fifth input port (Pi5), a 5:3 switchable combiner 24 can receive five incoming signals and produce three outgoing signals.

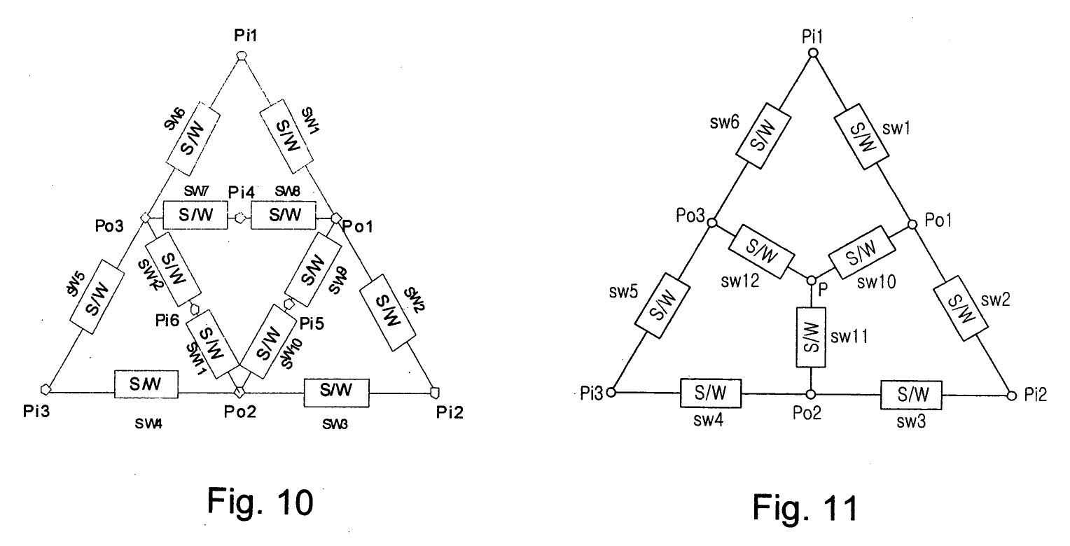

FIG. 10 depicts a diagram that when included with FIG. 6, provides three additional input ports (Pi4, Pi5 and Pi6) for receiving incoming signals. Additionally, a set of switches (sw7-sw12) connect the existing three output ports (Po1, Po2, and Po3) with three input ports (Pi4, Pi5, and Pi6). A 4:1 switchable combiner 24 receives four input signals that are applied from four input ports (Pi1, Pi3, Pi4, and Pi6) and that are applied through the output port (Po3). Additional output ports (Po1 and Po2) receive four input signals that are applied from four input ports (Pi6, Pi3, Pi5, Pi2 or Pi5, Pi2, Pi4, Pi1). Depending on the switching status, the combiner 24 operates a 6:3 switchable combiner.

FIG. 11 depicts three input ports (Pi1, Pi2, Pi3) that receive three incoming signals, three output ports (Po1, Po2, Po3), and six switches (sw1-sw6) that alternatively connect the three input ports and the three output ports in a circulating configuration. FIG. 11 also shows a redundancy input port (P) that switches (sw10, sw11 and sw12), and that connects the redundancy input port (P) to the output ports (Po1, Po2 and Po3).

Under normal operation, the switches (sw10, sw11 and sw12) are off. In the event of a failure at any of the input ports (Pi1, Pi2 and Pi3), the redundancy port (P) replaces the failed input port. For example, incoming signals (s1, s3) at input ports (Pi1, Pi3) are applied through the output port (Po3), and incoming signal (s2) at the input port (Pi2) is applied through the output port (Po2). If the first input port fails, switch (sw6) is turned off and switch (sw12) is turned on. Therefore, the first incoming signal (s1) is applied form the redundancy port (P), not from the first input port (Pi1) which is being applied through the third output port (P03). Note that the redundancy port (P) can also be utilized as an auxiliary input port.

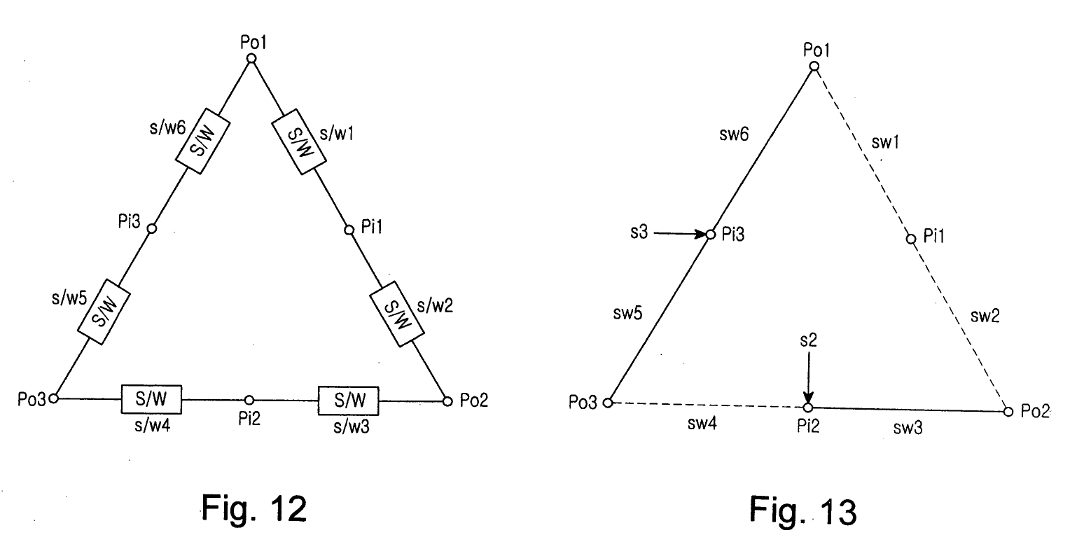

FIG. 12 depicts three input ports (Pi1, Pi2, Pi3), three output ports (Po1, Po2, Po3) and six switches (sw1-sw6). The switches alternatively connect the three input ports and the three output ports to each other in a circulating configuration. In this configuration, a 3:3 switchable divider receives three incoming signals from three input ports and applies the signals through three output ports. The output direction of the incoming signals depends on the status of the switches which are controlled by the control circuit 40.

FIG. 13 depicts an incoming signal (s3) that is applied to an input port (Pi3) and that is divided and applied through output ports (Po1 and Po3). An incoming signal (s2) is applied through an input port (Pi2) and is also applied through an output port (Po2).

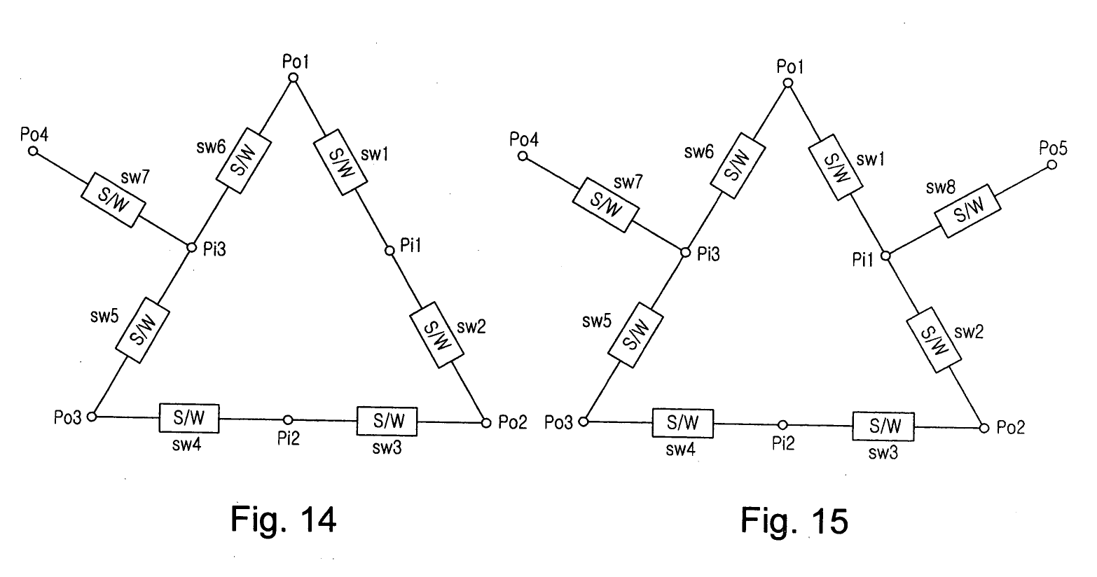

FIG. 14 depicts a fourth output port (Po4). When a seventh switch (S7) connects a third input port (Pi3) and a fourth output port (Po4), a 3:4 switchable divider receives three incoming signals from three input ports and applies the signals through four output ports. The third input port (Pi3) divides the incoming signal into a maximum of three outgoing signals.

FIG. 15, when combined with FIG. 14 adds a fifth output port (Po5) when an eighth switch (S8) connects a first input port (Pi1) to the fifth output port (Po5). A 3:5 switchable divider receives three incoming signals from three input ports and applies the signals through five output ports. The first and third input ports divide each incoming signal into a maximum of three outgoing signals.

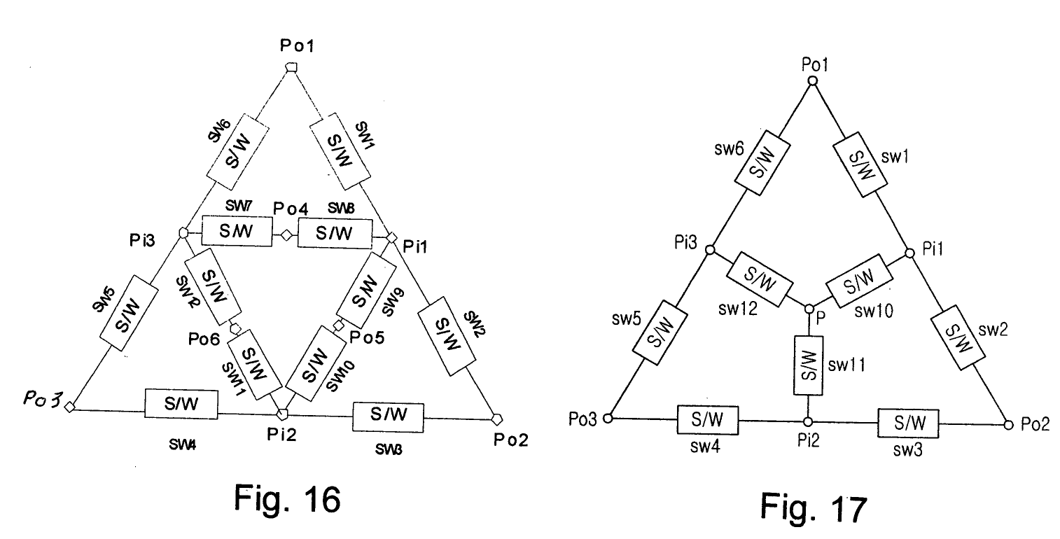

FIG. 16, when combined with FIG. 12, adds three output ports (Po4, Po5, Po6), and six switches (sw7-sw12) that connect three input ports (Pi1, Pi2, Pi3) with three output ports (Po4, Po5, P06). A 1:4 switchable divider receives an input signal that is applied from an input port (Pi1) and applies the signal to output ports (Po1, Po2, Po4, Po5). Additional input signals that are applied from input ports (Pi2, or Pi3) are applied through four output ports (Po3, Po6, Po5, Po2, or Po3, Po6, Po4, Po1).

FIG. 17 depicts three input ports (Pi1, Pi2, Pi3) that receive three incoming signals, three output ports (Po1, Po2, Po3), and six switches (sw1-sw6) that alternatively connect the three input ports and the three output ports to each other in a circulating configuration. A redundancy output port (P) is included that is controlled by switches (sw10, sw11 and sw12). The redundancy output port (P) functions with input ports (Pi1, Pi2 and Pi3).

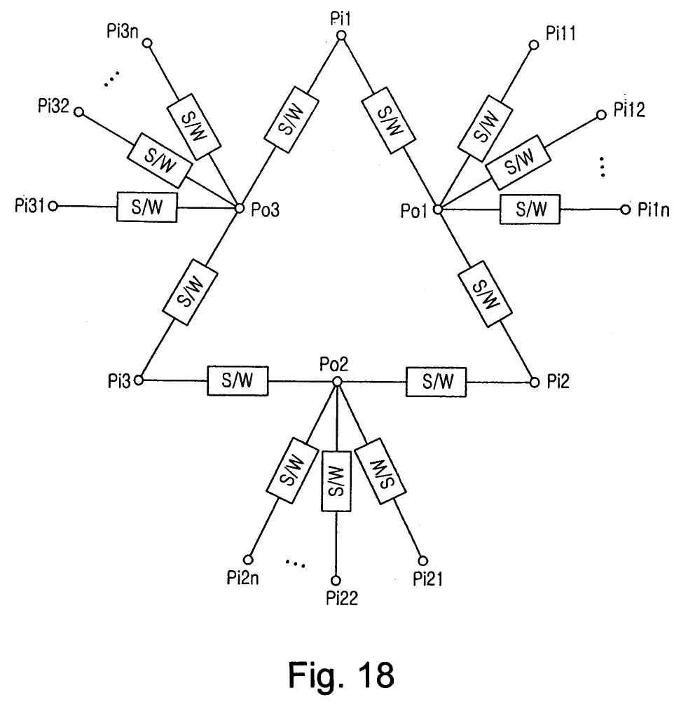

FIG. 18 shows each of the output ports (Po1, Po2 and Po3) connected to “n” input ports that are each controlled by a set of respective switches.

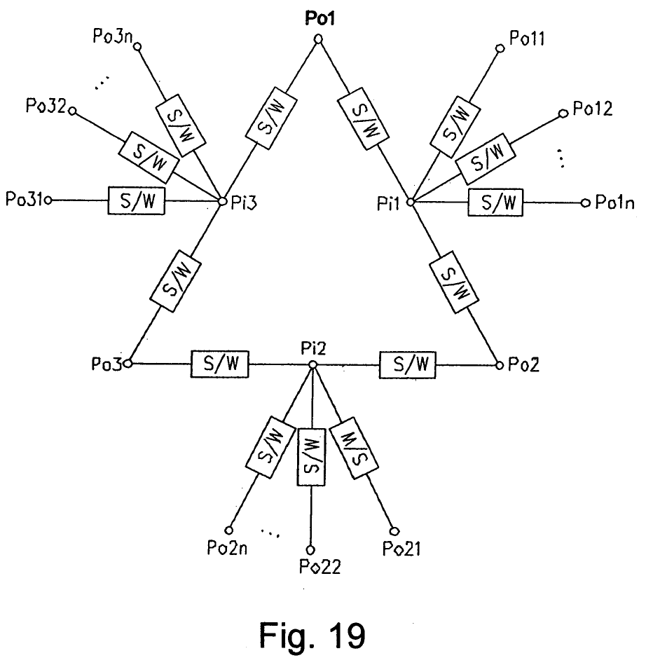

FIG. 19 shows each of the input ports (Pi1, Pi2 and Pi3) connected to “n” output ports that are each controlled by a set of respective switches.

While the invention has been described in detail and pictorially shown in the accompanying drawings it is not to be limited to such details, since many changes and modifications may be made to the invention without departing from the spirit and the scope thereof. Hence, it is described to cover any and all modifications and forms which may come within the language and scope of the appended claims.

1. A switchable divider and combiner assembly (SDCA) that operates in combination with a data processing/receiving network (50) that produces an output signal (11) and that receives an input signal (13), and a user (52) having a receiving/transmitting antenna (54), said SDCA comprises:
a) a base station (12),
b) a transceiver circuit (14) that is located within said base station (12), and having means for receiving and processing the output signal (11) and producing an input signal (Pi1),
c) a transmitting section (16) located within said base station (12), and comprising a divider circuit (18) having means for dividing the input signal (Pi1) into an output signal (Po1) and an output signal (Po5), wherein the two signals (Po1) and Po5) are applied to a combiner circuit (24), wherein the two signals are combined to produce an output signal (Po1) that is transmitted into space through a transmitting antenna (26) and that is received by the user (52) via a transmitting/receiving antenna (54),
d) a receiving section (30) located within said base station (12), and comprising a divider circuit (18) having a receiving antenna (36) that intercepts an input signal (Pi1) that is applied from the user (52), wherein said divider circuit (18) has means for dividing the input signal (Pi1) into an output signal (Po1) and an output signal (Po5), wherein the two signals (Po1 and Po5) are applied to a combiner circuit (24) where the two signals are combined to produce and output signal (Po1) that is applied to said transceiver circuit (14) from where the input signal (13) is applied to the data processing/receiving network (50), and
e) a control circuit (40) that is comprised of a microcontroller (40A) that is operated by firmware (40B) where said control circuit has means for controlling the operation of said transmitting section (16) and said receiving section (30).

2. The switchable divider and combiner assembly as specified in claim 1 wherein said means for dividing the signal applied to said divider circuit (18) comprises a plurality of switches.

3. The switchable divider and combiner assembly as specified in claim 2 wherein said means for combining the signals applied to said combiner circuit (24) comprises a plurality of switches.

4. The switchable divider and combiner assembly as specified in claim 3 wherein the operational sequence of said switches is controlled by said microcontroller.

5. The switchable divider and combiner assembly as specified in claim 1 wherein on said transmitting section (16), the signals applied from said divider circuit (18) are amplified by an amplifier prior to being applied to said combiner circuit.

6. The switchable divider and combiner assembly as specified in claim 5 wherein said amplifiers are comprised of R.F. power amplifiers.

7. The switchable divider and combiner assembly as specified in claim 1 wherein in said receiving section (30) the signals applied from said divider circuit (18) are amplified by an amplifier prior to being applied to said combiner circuit (24).

8. The switchable divider and combiner assembly as specified in claim 7 wherein said amplifier is comprised of a low-noise R.F. amplifier.

9. A switchable divider and combiner assembly (SDCA) that operates in combination with a data processing/receiving network (50) that produces an output signal (11) and that receives an input signal (13), and a user (52) having a receiving/transmitting antenna (54), said SDCA comprising:
a) a base station (12),
b) a transceiver circuit (14) located within said base station (12) and having means for receiving and processing the output signal (11) and producing an input signal (Pi1), and means for receiving an output signal (Po1) and producing an output signal (13),
c) a transmitting section (16) comprising:
(1) a divider circuit (18) having means for dividing and switching the input signal (Pi1) into a first signal (Pi1′) and a second signal (Pi1″), wherein the first signal (Pi1′) is applied to a first switch (S1), and the second signal (Pi1″) is applied to an eighth switch (S8), wherein when the first switch (S1) closes, an output signal (Po1) is produced, and when the eighth switch (S8) closes, an output signal (Po5) is produced, wherein the output signal (Po1) from the first switch (S1) is applied to an RF power amplifier (20) that is designed to produce an amplified input signal (Pi1′), and wherein the output signal (Po5) from the eighth switch (S8) is applied to a low-noise RF power amplifier (22) that is designed to produce an amplified input signal (Pi5′),
(2) a combiner circuit (24) comprised of a first switch (S1) and an eighth switch (S8), wherein the first switch (S1) is applied the amplified input signal (Pi1′) and the eighth switch (S8) is applied the amplified input signal (Pi5′), wherein when the two switches (S1,S8) close, the two signals (Pi1′) and PiS′) are combined to produce an output signal (Po1) that is applied to the RF transmitting antenna (26) that transmits the output signal (Po1) into space, wherein the signal is intercepted by a transmitting/receiving antenna (54) from where the signal is applied to the user (52),
d) a receiving section (30) comprising:
(1) a receiving antenna (36) that intercepts an input signal (Pi1) that is produced by the user (52), and that is applied to a divider circuit (18) having means for dividing and switching the input signal (Pi1) into a first signal (Pi1′) and a second signal (Pi1″), wherein the first signal (Pi1′) is applied to a first switch (S1), and the second signal (Pi1″) is applied to an eighth switch (S8), wherein when the first switch (S1) closes, an output signal (Po1) is produced, and when the eighth switch (S8) closes, an output signal (Po5) is produced. The output signal (Po1) from the first switch (S1) is applied to an RF power amplifier (34) that is designed to produce an amplified output signal (Po1′), wherein a low-noise RF power amplifier (36) receives the output signal (Po5) from the eighth switch (S8) and produces an amplified output signal (Po5′),
(2) a combiner circuit (38) that is comprised of a first switch (S1) and an eighth switch (S8), wherein the first switch (S1) is applied the amplified output signal (Po1′), and the eighth switch (S8) is applied the amplified input signal (Po5′), wherein when the two switches (S1, S8) close, the two signals (Po1′) and (Po5′) are combined by the combiner circuit (38) to produce an output signal (Po1) that is applied to said transceiver circuit (14) from where the output signal (13) is produced and applied to the data producing/receiving network (50), and
e) a control circuit (26) that is comprised of a microcontroller (26A) that is operated by firmware (26B) wherein said control circuit (26) has means for selecting and controlling the operating sequence of the switches (S1 and S8) located in the transmitting section (16) and the switches (S1 and S8) located in the receiving section (30).

10. The switchable divider and combiner assembly as specified in claim 9 wherein said firmware is comprised of the following sequential steps:
a) start,
b) initialization,
c) waiting for a command signal from said microcontroller,
d) receiving the command signal from said microcontroller,
e) decoding the command signal, and
f) reporting the current switch status to said microcontroller.

11. The switchable divider and combiner assembly as specified in claim 10 wherein said divider circuit (18) further comprises:
a) an input signal (Pi1),
b) a second switch (S2),
c) an eighth switch (S8),
d) an output signal (Po2), and
e) an output signal (Po5), wherein the input signal (Pi1) is divided by said divider circuit (18) into a first signal and a second signal, wherein the first signal is applied to the second switch (S2), wherein when the second switch (S2) closes the output signal (Po2) is produced, wherein the second signal is applied to the eighth switch (S8), wherein when the eighth switch (S8) closes the output signal (Po5) is produced.

12. The switchable divider and combiner assembly as specified in claim 10 wherein said divider circuit (18) further comprises:
a) an input signal (Pi2),
b) a third switch (S3),
c) a ninth switch (S9),
d) an output signal (Po2), and
e) an output signal (Po6), wherein the input signal (Pi2) is divided by said divider circuit (18) into a first signal and a second signal, wherein the first signal is applied to the third switch (S3), wherein when the third switch (S3) closes the output signal (Po2) is produced, wherein the second signal is applied to the ninth switch (S9), wherein when the ninth switch (S9) closes the output signal (Po6) is produced.

13. The switchable divider and combiner assembly as specified in claim 10 wherein said divider circuit (18) further comprises:
a) an input signal (Pi2),
b) a fourth switch (S4),
c) a ninth switch (S9),
d) an output signal (Po3), and
e) an output signal (Po6), wherein the input signal (Pi2) is divided by said divider circuit (18) into a first signal and a second signal, wherein the first signal is applied to the fourth switch (S4), wherein when the fourth switch (S4) closes the output signal (Po3) is produced, wherein the second signal is applied to the ninth switch (S9), wherein when the ninth switch (S9) closes the output signal (Po6) is produced.

14. The switchable divider and combiner assembly as specified in claim 10 wherein said divider circuit (18) further comprises:
a) an input signal (Pi3),
b) a sixth switch (S6),
c) a seventh switch (S7),
d) an output signal (Po1), and
e) an output signal (Po4), wherein the input signal (Pi3) is divided by said divider circuit (18) into a first signal and a second signal, wherein the first signal (Pi3) is applied to the sixth switch (S6), wherein when the sixth switch (S6) closes the output signal (Po1) is produced, wherein the second signal is applied to the seventh switch (S7), wherein when the seventh switch (S7) closes the output signal (Po4) is produced.

15. The switchable divider and combiner assembly as specified in claim 10 wherein said divider circuit (18) further comprises:
a) an input signal (Pi3),
b) a fifth switch (S5),
c) a seventh switch (S7),
d) an output signal (Po3), and
e) an output signal (Po4), wherein the input signal (Pi3) is divided by said divider circuit (18) into a first signal (Pi3) and a second signal (Pi3), wherein the first signal is applied to the fifth switch (S5), wherein when the fifth switch (S5) closes the output signal (Po3) is produced, wherein the second signal is applied to the seventh switch (S7), wherein when the seventh switch (S7) closes the output signal (Po4) is produced.

16. The switchable divider and combiner assembly as specified in claim 10 wherein said combiner circuit (24) further comprises:
a) an input signal (Pi1),
b) an input signal (Pi4),
c) a sixth switch (S6),
d) a seventh switch (S7), and
e) an output signal (Po3), wherein the sixth switch (S6) is applied the input signal (Pi1) and the seventh switch (S7) is applied the input signal (Pi4), wherein when the switch (S6) and the switch (S7) close, the two signals (Pi1) and (Pi4) are combined to produce an output signal (Po3).

17. The switchable divider and combiner assembly as specified in claim 10 wherein said combiner circuit further comprises:
a) an input signal (Pi2),
b) an input signal (Pi5),
c) a second switch (S2),
d) a sixth switch (S6), and
e) an output signal (Po1), wherein the seventh switch (S2) is applied the input signal (Pi2) and the sixth switch (S6) is applied the input signal (Pi5), wherein when the switch (S2) and the switch (S6) close, the two signals (Pi2) and (Pi5) are combined to produce an output signal (Po1).

18. The switchable divider and combiner assembly as specified in claim 10 wherein said combiner circuit further comprises:
a) an input signal (Pi3),
b) an input signal (Pi6),
c) a fourth switch (S4),
d) a ninth switch (S9), and
e) an output signal (Po2), wherein the fourth switch (S4) is applied the input signal (Pi3) and the ninth switch (S9) is applied the input signal (Pi6), wherein when the switch (S4) and the switch (S9) close, the two signals (Pi3) and (Pi6) are combined to produce an output signal (Po2).

19. The switchable divider and combiner assembly as specified in claim 10 wherein said combiner circuit further comprises:
a) an input signal (Pi3),
b) an input signal (Pi4),
c) a fifth switch (S5),
d) a seventh switch (S7), and
e) an output signal (Po3), wherein the fourth switch (S4) is applied the input signal (Pi3) and the seventh switch (S7) is applied the input signal (Pi4), wherein when the switch (S5) and the switch (S7) close, the two signals (Pi3) and Pi4) are combined to produce an output signal (Po3).

20. The switchable divider and combiner assembly as specified in claim 10 wherein said combiner circuit further comprises:
a) an input signal (Pi2),
b) an input signal (Pi6),
c) a third switch (S3),
d) a ninth switch (S9), and
e) an output signal (Po2), wherein the third switch (S3) is applied the input signal (Pi2) and the ninth switch (S9) is applied the input signal (Pi6), wherein when the switch (S3) and the switch (S9) close the two signals (Pi2) and Pi6) are combined to produce an output signal (Po2).
